(19) United States
(12) Patent Application Publication
(10) Pub. No.: US 2025/0275016 A1
(43) Pub. Date: Aug. 28, 2025

(54) Electric Heating Device

(71) Applicant: Eberspächer catem GmbH & Co. KG, Herxheim (DE)

(72) Inventors: Philip Rabe, Neustadt an der Weinstrasse (DE); Felix Terlinden, Reilingen (DE)

(21) Appl. No.: 19/059,425

(22) Filed: Feb. 21, 2025

(30) Foreign Application Priority Data
Feb. 23, 2024 (DE) 10 2024 105 187.6

(51) Int. Cl. H05B 3/04; H05B 3/00

(52) U.S. Cl. CPC H05B 3/04; H05B 3/0042

(57) ABSTRACT

An electrical heating device for a motor vehicle includes a housing which encloses a heating chamber which is coupled in a thermally conductive manner to an electrical resistance element and which encloses a control device. The electric heating device further has a pressure equalizing device for equalizing a pressure difference between the interior of the housing and the environment of the housing. The pressure equalizing device is sealingly inserted in a receiving bore which is formed to receive the pressure equalizing device and which is recessed in the housing.

### BACKGROUND OF THE INVENTION

### 1. Field of the Invention

The present invention relates to an electric heating device.

### 2. Discussion of the Related Art

An electric heating device known from EP 3 334 242 A1, the subject matter of which is incorporated by reference by way of background information, is considered to be of the same general type.

In the aforementioned prior art, the one electrical heating device has a control housing that is connected to the plug-in contact with contact elements for the power current or to the plug-in contact with contact elements for control signals with corresponding interfaces. These interfaces also allow gas exchange between the inside of the housing and the environment and thus pressure equalization.

On this basis, the present invention seeks to provide an electrical heating device which can be adapted to different requirements in an improved manner.

### SUMMARY

To solve this problem, the present invention proposes an electrical heating device, typically configured for use in a motor vehicle, which comprises a housing and a pressure equalization device. The housing encloses a control device and also encloses a heating chamber which is coupled in a thermally conductive manner to an electrical resistance element, the housing enclosing a control device. The pressure equalization device is configured to equalize a pressure difference between the interior of the housing and the environment of the housing. The pressure equalization device is inserted in a sealing manner in a receiving bore which is designed to be adapted to receive the pressure equalization device and which is recessed in the housing.

In the electrical heating device according to the invention, the housing, which is usually formed of metal at least with its housing part surrounding the control device, may have a receiving bore which passes through a wall of the housing and accordingly connects the interior of the housing, in particular the part of the housing receiving the control device, to the environment. This locating hole may be specially adapted to accommodate a pressure equalization device. Accordingly, the mounting hole has a dimension that is precisely adapted to accommodate the pressure equalization device. The pressure equalization device is generally used solely to equalize a pressure difference between the inside of the housing and the surroundings of the housing.

In this way, the electrical heating device according to the invention enables pressure equalization between the interior and exterior, for example, due to temperature changes.

According to a possible further development of the present invention, the pressure equalization device may be screwed into the receiving bore, for which purpose the pressure equalization device, in particular a pressure equalization plug thereof, is generally provided with an external thread and the receiving bore with an internal thread. Alternatively, the pressure equalization device can also be mounted in the locating hole in the form of a clip. For this purpose, the pressure equalization plug can be inserted into the locating bore and provided with locking tabs on its underside, for example, which protrudes into the housing.

The pressure equalization plug may be penetrated by a pressure equalization channel, which usually extends centrally within the receiving bore in the longitudinal direction thereof and is closed by an air-permeable but water-impermeable device. This device is used to retain moisture, in particular water in liquid or vapor form. This device can be made of metal or plastic, in particular as a membrane that provides a different permeability for gases and moisture. Such properties can also be provided by filters made of plastic, natural material such as cellulose fibers, and/or metal.

The device may be provided on the outside of the pressure compensation plug, and may be connected to the front of this pressure compensation plug. For this purpose, the pressure compensation plug may have a radial flange that is wider than the rest of its outer diameter, on the front of which the device can be applied, in particular in the form of a diaphragm, and connected to it with a material bond. On the side opposite the device, there is usually a sealing ring between the radial flange and the housing, via which the pressure equalization device is sealed off from the housing.

Instead of a separate sealing ring, it is also possible to form a seal as an integral part of the pressure compensation plug, for example by overmolding the pressure compensation plug with a soft elastic plastic.

The membrane can be flexible in order to compensate for certain pressure fluctuations within the control housing through elastic deformation. More typically, however, the diaphragm is permeable to air and impermeable to water, so that air can escape from the control housing in the event of any overpressure or air can flow into the control housing through the diaphragm in the event of a certain negative pressure, so that pressure equalization is achieved within the control housing. Simple systems with only one membrane or multi-part systems with a multilayer film structure can be used for venting, whereby different layers of the film structure can have different functions such as a mechanical function or a retaining function. A sintered filter can also be used as a mechanism via which of ventilation through the pressure equalization channel may be achieved.

The membrane can be welded, such as ultrasonically welded, to the pressure equalization plug. Alternatively or additionally, the diaphragm can be bonded to the pressure equalization plug.

It has been found that an air-permeable but liquid-impermeable membrane may be made of ePTFE or PTFE. This membrane should have a thickness between 120 μm and 240 μm, in particular 180 μm +/−50 μm. Practical tests by the applicant have shown that such a membrane prevents water or water vapor from entering the control housing, but air can escape from the control housing through the membrane.

A cover cap may be provided on the outside of the housing and usually covering the diaphragm, which is connected to the pressure equalization plugs, such as being latched or pressed.

This cover cap can also be formed integrally on the pressure compensation plug, for example on a uniform injection-molded component, while retaining a compensation channel within the pressure compensation plug. In such a variant in particular, the diaphragm may be located at the end of the pressure compensation plug that protrudes into the housing and can be connected there to the pressure compensation plug in the manner described above.

This cover cap and/or the pressure equalization plug can be made of plastic or metal. It is understood that a compensation gap for pressure equalization purposes may be provided between the cover cap and a frontal opening to the pressure equalization channel, which is usually covered by the diaphragm.

The housing may be thickened in the area of the locating bore, whereby the locating bore is provided with sufficient length for a firm connection with the pressure equalization device, in particular the pressure equalization plug inserted into the locating bore.

### BRIEF DESCRIPTION OF THE DRAWINGS

Further details and advantages of the present invention can be seen from the following description of an embodiment in conjunction with the drawing. In this show:

FIG. 1: An exploded perspective view of an embodiment of the present invention;

FIG. 2: an enlarged perspective top view of a part of the housing according to Figure comprising the pressure equalization device;

FIG. 3: a longitudinal sectional view along line III-III as shown in FIG. 2.

### DETAILED DESCRIPTION

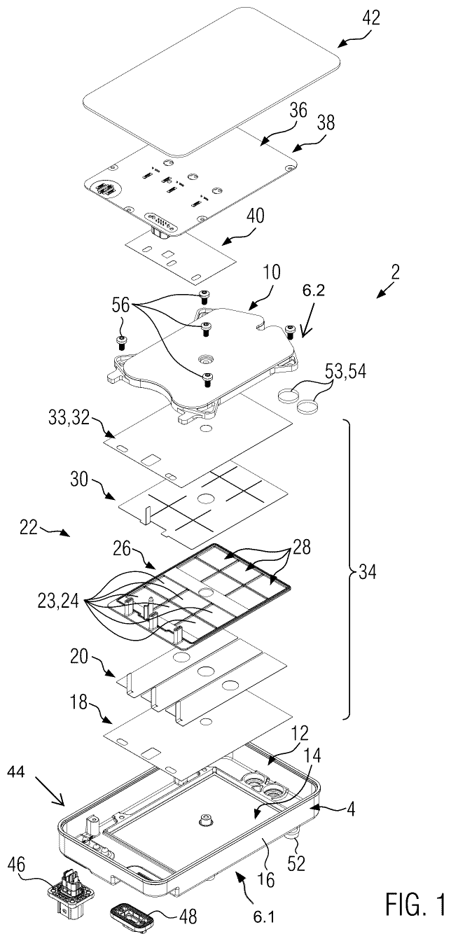

FIG. 1 shows an electrical heating device 2 with a housing base part 4, which is connected to a heating chamber cover, not shown here, on its lower side in FIG. 1 to form a first heating chamber 6.1. Reference sign 10 indicates a fluid housing which is accommodated in a receiving space 12 formed by the housing base part 4 and forms a second heating chamber 6.2. In this receiving space 12, which is bounded on the underside by a base 14 and on the edge by a circumferential wall 16 extending from the base 14, and between the base 14 and the fluid housing 10, there is a first insulating layer 18, which can be placed against the base 14, a first contacting layer 20 and a heating device 22 with a plurality of electrical resistance elements 23, in the present case in the form of PTC elements 24, and a positioning frame 26 with receptacles 28 for receiving the PTC elements 24.

On the side of the heating device 22 opposite the first contacting layer 20, a second contacting layer 30 is provided, on the side of which opposite the heating device 22 a second insulating layer 32 is arranged. The PTC elements are therefore electrically conductive against the contacting layers 20, 30 and are energized via these. The PTC elements 24 are ceramic cuboid components, which are provided with a metallization on opposite main side surfaces for current conduction. The main side surface is the surface of the cuboid with the largest surface area. The main side surfaces are connected to each other by edge surfaces, which determine the height of the PTC elements and do not have any metallization. The main side surfaces are generally each larger by a factor of 5 than one of the edge surfaces, typically than the sum of all the edge surfaces.

The second insulating layer 32 is formed as a prestressing device 33 by a silicone film, which is able to absorb certain compressions by elastic deformation and thus apply the electrical heating device 22 between the housing base part 10 and the housing base 14 under prestress against the housing base part 10 and the housing base 14.

The layering of the first insulating layer 18, the first contacting layer 20, the heating device 21, the second contacting layer 30 and the second insulating layer 32 is hereinafter also referred to as a layered structure 34.

On the side of the fluid housing 10 facing away from this layered structure 34, a transistor insulation 40 is located between a printed circuit board 38 forming a control device 36 and the fluid housing 10 in the embodiment example shown. Reference sign 42 identifies a housing cover which is connected to the housing base part 4 to form a housing identified by reference sign 44. The housing base part 4 and the housing cover 42, and possibly other housing parts, are of shielding design, i.e. made of metal and/or provided with a separate shielding on the inside, outside or in the walls of the respective housing part, which may be made of plastic. A possible metallic material is aluminum or stainless steel for corrosion resistance.

A power connector 46 and a control connector 48 are shown in FIG. 1 on the underside of the housing base part 4 opposite this housing cover 42. These two plugs 46, 48 are connected to the housing base part 4 in a sealed manner and have various male electrical plug contacts which are led through the respective housings of the plugs 46, 48 in a sealed manner and are plug-contacted in the printed circuit board 38 and are electrically connected to conductor tracks of the printed circuit board 38 via this plug contacting. Details of this are described below in connection with FIG. 4. For the plug-in contact, the printed circuit board 38 has female contact tongue receptacles, which are described in EP 2 236 330 A1.

Furthermore, inlet and outlet nozzles 50, 52 are provided on the underside for the connection of pipes or hoses carrying the fluid to be heated. Reference sign 53 indicates the sealing arrangement 53 shown in FIG. 1 below the fluid housing 10, which in the present case is formed by two sealing rings 54. Reference sign 56 indicates screws for fixing the fluid housing 10 relative to the housing base part 4 with the layered structure 34 interposed. This screw connection places the layers of the layered structure 34 under preload against the fluid housing 10 and the base 14 of the housing base part 4.

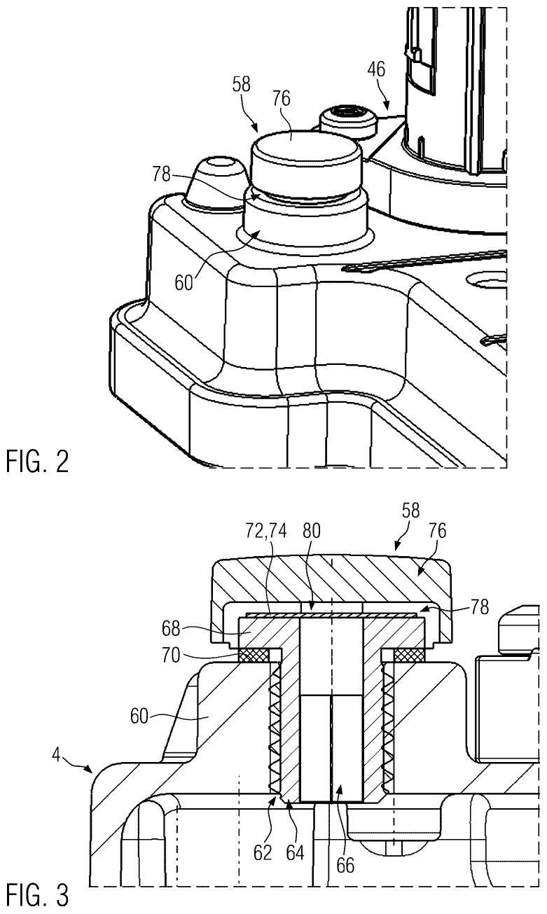

FIGS. 2 and 3 show details of a pressure equalization device 58, which is arranged adjacent to the power connector 46 on the housing base part 4. For this purpose, the housing base part 4 has an elevation 60, by which the wall thickness of the housing base part 4 is increased (see FIG. 3). This elevation 60 is provided with a receiving bore 62, which has an internal thread to which an external thread of a pressure equalization plug 64 is screwed. The pressure equalization plug 64 is penetrated by a pressure equalization channel 66 extending in the longitudinal direction of the receiving bore 62 and has a radial flange 68 provided on the outside of the elevation 60, which receives a sealing ring 70 between itself and an end face of the elevation 60, whereby the receiving bore 62 is sealed towards the outside. On the side opposite the sealing ring 70 and on the free end face of the pressure equalization plug 64, there is a membrane 74 as an example of a device 72 for closing the pressure equalization channel 66 in an air-permeable but water-impermeable manner, which membrane 74 is welded to the pressure equalization plug 64 in the embodiment example shown. The pressure equalization plug 64 is made of plastic in the present case.

In FIGS. 2 and 3, reference sign 76 indicates a cover cap covering the diaphragm, which is connected to the pressure equalization plug 64. As illustrated in particular in FIG. 3, an equalizing channel 78 remains between the outer surfaces of the pressure equalizing plug 64 and the diaphragm 74, which extends between an orifice 80 of the pressure equalizing channel 66 and an end of the cover cap 76 facing the elevation 60. The cover cap 76 thus permits mechanical protection of the diaphragm 74, but at the same time also pressure equalization between the inside of the housing 44 and the outside.

1. An electrical heating device for a motor vehicle, the electrical heating device comprising:
a housing which encloses a heating chamber which is coupled in a thermally conductive manner to an electrical resistance element, the housing enclosing a control device; and
a pressure equalization device for equalizing a pressure difference between the interior of the housing and the environment of the housing, which pressure equalization device is inserted in a sealing manner in a receiving bore which is designed to be adapted to receive the pressure equalization device and which is recessed in the housing.

2. The electrical heating device according to claim 1, wherein the pressure compensation device is screwed into the receiving bore.

3. The electrical heating device according to claim 2, wherein the pressure equalization device has a pressure equalization plug through which a pressure equalization channel passes, wherein the equalization channel is closed by an air-permeable but water-impermeable device.

4. The electrical heating device according to claim 3, wherein the water-impermeable device comprises a diaphragm which is connected to the pressure compensation plug.

5. The electrical heating device according to claim 4, wherein the diaphragm is connected to the pressure compensation plug with a material bond.

6. The electrical heating device according to claim 4, wherein the pressure equalizing device has a cover cap which covers the diaphragm and is connected to the pressure equalizing plug.

7. The electrical heating device according to claim 4, wherein the membrane is formed from PTFE and has a thickness of between 120 μm and 240 μm.

8. The electrical heating device according to claim 7, wherein the membrane has a thickness of between 150 μm and 190 μm.

9. The electrical heating device according to claim 6, wherein the diaphragm is made of metal.

10. The electrical heating device according to claim 1, wherein the pressure equalizing device comprises a sealing ring, and wherein the pressure equalizing device and the sealing ring are integrally formed.
